(19) United States
(12) Patent Application Publication
(10) Pub. No.: US 2008/0245356 A1
(43) Pub. Date: Oct. 9, 2008

(54) Grill frame and turnable grill

(76) Inventor: Pi-Chu Chuang, Round Rock, TX (US)

Correspondence Address: OSHA LIANG L.L.P., 1221 MCKINNEY STREET, SUITE 2800, HOUSTON, TX, 77010, US

(21) Appl. No.: 11/784,394

(22) Filed: Apr. 6, 2007

(51) Int. Cl. A47J 37/07

(52) U.S. Cl. 126/25 R

(57) ABSTRACT

A grill assembly includes a grill frame having a first pair of notches on a first side of the grill frame and a second pair of notches on another side of the grill frame that is opposite the first side, wherein the first pair of notches and the second pair of notches are aligned along two axes of rotation that are substantially perpendicular to the first side of the grill frame; and a grill comprising two halves held together by a hinge such that the two halves can be folded to face each other, and four axle portions that are configured to fit in the first pair of notches and the second pair of notches of the grill frame.

### BACKGROUND OF INVENTION

1. Field of the Invention

The present invention relates to apparatus for grilling or barbequing food over a fire or other source of heat. More particularly, the present invention relates to turnable grill assembly or equipment having turnable grills for easy cooking or barbequing.

2. Background Art

Outdoor cooking using barbeque grills to cook and heat food with gas, charcoal or other heat source has become very popular in many parts of the world. In the U.S., many households have movable or fixed grill or barbecue setup. In addition, many counties and states have installed barbeque pits/grills along public roadways and in public parks for use by picnickers and travelers. More recently, some new homes have installed outdoor kitchens that include fixed cooking stove and/or grills.

During grilling or barbequing, foods are placed on a grill that typically includes a frame and a plurality of wires, bars, or rods attached to the frame to hold the food above a fire. FIG. 1 shows a typical prior art grill that includes a frame 11 and a plurality of wires, bars, or rods 12 arranged in parallel to hold the food. The spacings between the wires, bars, or rods 12 allow the flame and smoke to reach the food to give the grill food special flavors. The spacings between the wires, bars, or rods 12 also permit the fat and oil from meat to drip down and be drained away from the meat. In some grills, the wires, bars, or rods may be arranged in grid or other patterns.

Because barbeque or grill setup heats the food from underneath the grill, if cooking both sides (up and down sides) of a food item (e.g., a steak or hamburger patty) is desired, a user will need to flip the food item during cooking. Many barbeque hand tools have been developed to facilitate the cooking and flipping of foods (e.g., steaks, chops, fish, and the like) on a grill. Among the common barbeque tools utensils are forks, tongs and spatulas. These can be simple utensils or more elaborate ones to make the task easier. For example, U.S. Pat. No. 4,844,525, issued to Tarlow et al. discloses a combination fork with a spatula that can grip foods by the action of the user pulling on a trigger located within the handle of the tool. With such common barbeque tools, a user would twist his or her wrist or hand to flip the item over. Turning or flipping a food item can be tricky at times.

To improve the situation, U.S. Pat. No. 7,100,953 issue to Tarlow et al. discloses a new barbeque utensil that can grip, lift and flip an item of food without the need to twist a user's wrist in the process. Such a utensil includes a mechanism to rotate the gripping end by 180 degrees when a user pull a trigger located at the handle, thereby creating a flipping action.

While such improvement in barbeque utensils makes it easier to cook foods on a grill, there still exists a need for better design to further streamline the cooking and/or barbequing process.

### SUMMARY OF INVENTION

In one aspect, the present invention relates to grill assemblies. A grill assembly in accordance with one embodiment of the invention includes a grill frame having a first pair of notches on a first side of the grill frame and a second pair of notches on another side of the grill frame that is opposite the first side, wherein the first pair of notches and the second pair of notches are aligned along two axes of rotation that are substantially perpendicular to the first side of the grill frame; and a grill comprising two halves held together by a hinge such that the two halves can be folded to face each other, and four axle portions that are configured to fit in the first pair of notches and the second pair of notches of the grill frame.

Other aspects and advantages of the invention will become apparent from the following description and the attached claims.

### BRIEF SUMMARY OF THE DRAWINGS

FIG. 1 shows a conventional grill having a plurality of bars arranged on a frame to provide a cooking surface.

FIG. 2 shows a grill in accordance with one embodiment of the invention.

FIG. 3 shows a grill frame in accordance with one embodiment of the invention.

FIG. 4 shows a grill assembly comprising the grill of FIG. 2 and the grill frame of FIG. 3 in accordance with one embodiment of the invention.

FIG. 5 shows the grill assembly of FIG. 4 wherein the two halves of the grilled are folded to face each other in accordance with one embodiment of the invention.

FIG. 6 shows a schematic illustrating a side view of the grill assembly of FIG. 5 in accordance with one embodiment of the invention.

FIG. 7 shows a schematic illustrating a side view of the grill assembly of FIG. 6 in the process of being rotated in accordance with one embodiment of the invention.

FIG. 8 shows a schematic illustrating an axle formed of two (half cylinder) axle portions accommodated in a notch during rotation, wherein the notch prevents the two axle portions from separating, in accordance with one embodiment of the invention.

FIG. 9 illustrates a grill frame having legs in accordance with one embodiment of the invention.

FIG. 10 illustrates a side view of a folded grill illustrating the wavy pattern of bar arrangements in accordance with one embodiment of the invention.

FIG. 11 illustrates a side view of a folded grill illustrating the wavy pattern of bar arrangements in accordance with another embodiment of the invention.

FIG. 12 illustrates a side view of a folded grill illustrating a mixed pattern of bar arrangements in accordance with one embodiment of the invention.

### DETAILED DESCRIPTION

Embodiments of the invention relate to barbeque grills and cooking apparatus. Particularly, embodiments of the invention related to “tunable” or “flappable” grills for use with barbeque apparatus or similar cook tops. Grills of the invention facilitate cooking both sides of a food item.

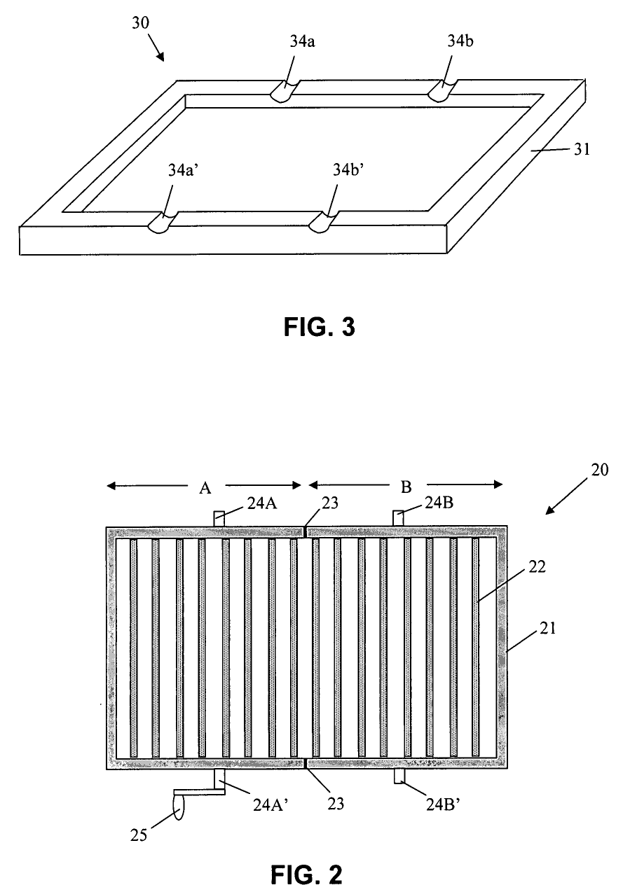

FIG. 2 shows a grill in accordance with one embodiment of the invention. As shown in FIG. 2, a barbeque grill 20 includes a frame 21 and a plurality of wires, bars, or rods 22 arranged on the frame 21. In this description, “bars” will be used as a broad term that include wires, bars, rods, and the like. The plurality of bars 22 are shown arranged in parallel. However, one of ordinary skill in the art would appreciate that other arrangements, such grid patterns, may also be used without departing from the scope of the invention. The frame 21 comprise two sections linked by a hinge 23 such that the grill may be folded in half. That is, the grill 20 may be viewed as made of two halves A and B that is attached to each other by a hinge 23. “Hinge” is used in a broad sense in this description and refers to any mechanism that allows the two halves A and B to be opened and closed like a book.

In addition, grill 20 also includes axle portions 24A, 24A′, 24B, and 24B′ attached to the outside of the frame 21. These axle portions are to be used with an outside frame of the invention (shown as 30 in FIG. 3) and will be explained in detail later. In addition, the grill 20 may include a handle 25 to facilitate the turning or flipping during cooking. In the particular embodiment shown, there is only one handle 25 attached to axle portion 24A′. In accordance with other embodiments of the invention, the handle 25 may be attached to the axle portion 24B′. In accordance with some embodiments of the invention, two handles may be attached to the axle portions 24A′ and 24B′. If two handles are included, it is preferred that both handles will line up (superimpose) to form “a handle” when one half of the grill is folded on top of the other half (see FIG. 5). Furthermore, in accordance with some embodiments of the invention, the handle 25 may be omitted or be removably attached to the axle portion. If no handle is included, the axle portion (e.g., 24A′ and/or 24B′) may be extended a bit longer for use to rotate the grill (how to rotate/turn a grill of the invention will be described later).

In the particular embodiment of FIG. 2, the axle portions 24A and 24A′, as well as axle portions 24B and 24B′, are shown as separate pieces attached to outside of the frame 21. In accordance with other embodiments of the invention, these axle portions (24A and 24A′, or 24B and 24B′) may be a unitary piece (i.e., a long axle). Similarly, the hinges 23 shown in FIG. 2 are separate pieces. However, the hinges 23 may also be a continuous piece running across the width of the frame 21.

FIG. 3 shows a grill frame 30 in accordance with one embodiment of the invention. As shown, the grill frame 30 includes a pair of notches 34a and 34b disposed on a first side (top side in FIG. 3) of the grill frame and another pair of notches 34a′ and 34b′ disposed on another side (bottom side) of the grill frame that is opposite the first side. These notches are configured to accommodate the axle portions (shown as 24A, 24A′, 24B, 24B′ in FIG. 2) on a grill (e.g., 20 in FIG. 2) in accordance with embodiments of the invention. The notches 34a and 34a′ are configured to be aligned with a rotation axis (not shown) that is substantially parallel with the left and right sides of the grill frame. Similarly, notches 34b and 34b′ are aligned along a rotational axis that is substantially parallel with the left and right sides of the grill frame. In accordance with embodiments of the invention, the notches 34a, 34a′, 34b, 34b′ are preferably cutouts (indentations) having a half cylinder shape, i.e., having a semicircular cross section, as shown in FIG. 3. However, one of ordinary skill in the art would appreciate that notches with other configurations (e.g., square notches, trapezoid notches, etc.) may also be used without departing from the scope of the invention.

The grill frame shown in FIG. 3 has a square profile. This is for clarity of illustration only. One of ordinary skill in the art would appreciate that a grill frame of the invention may also have other profiles. In accordance with embodiments of the invention, the top side and the bottom side of the grill frame are preferably substantially straight, but the right and left sides of the grill frame shown in FIG. 3 may have different shapes.

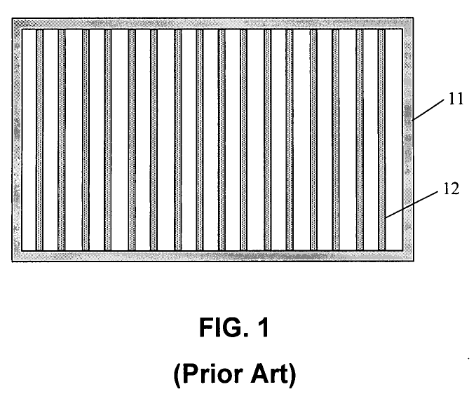

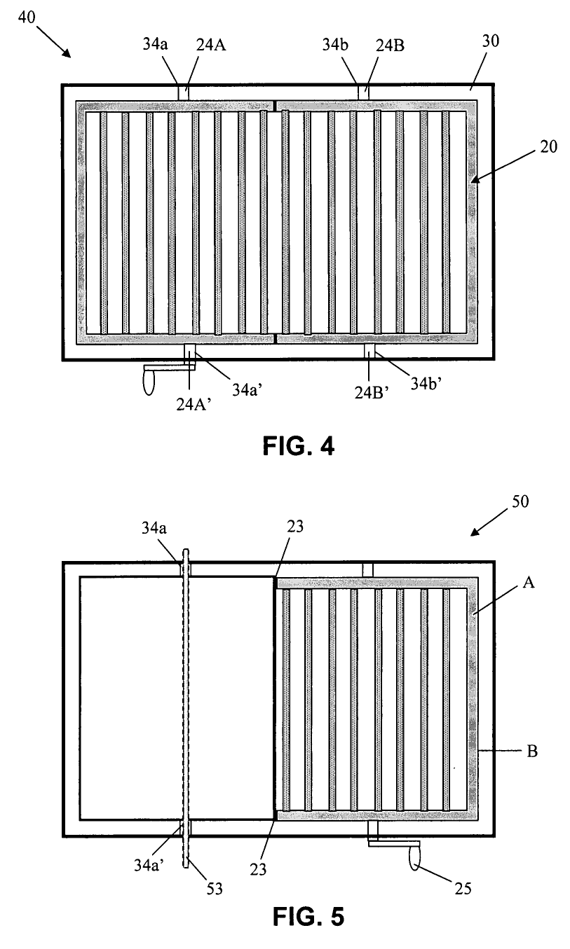

FIG. 4 illustrates a grill assembly 40 in accordance with one embodiment of the invention. As shown, the grill assembly 40 comprises a grill frame 30 of FIG. 3 and a grill 20 of FIG. 2. When assembled as shown in FIG. 4, the axle portion 24A seats in notch 34a; the axle portion 24A′ seats in notch 34a′; the axle portion 24B seats in notch 34b; and the axle portion 24B′ seats in notch 34b′. In this configuration, the grill assembly 40 may be used in a manner similar to a conventional grill (such as that shown in FIG. 1). For use in this manner, the grill frame 30 and the grill 20 may have any profile (other than the square profiles shown in FIG. 2 and FIG. 3). However, in accordance with preferred embodiments of the invention, the grill assembly 40 may be used in a manner in which the grill 20 is folded and rotated on the grill frame 30 (to be described in detail later). When rotation is desired, the shape and profile of the grill 20 and the grill frame 30 should be selected such that they permit rotation of the folded grill.

FIG. 5 illustrates a configuration of a grill assembly 50 during use in accordance with one embodiment of the invention. As shown in FIG. 5, the A half (see FIG. 2) of the grill is folded over the B half (see FIG. 2) of the grill. The folding of A half over B half is made possible by the hinge (shown as 23 in FIG. 2) at the middle of the grill. To fold the A half over B half, a user may grab the handle 25 (or axle portion 24A′) and swing the A half over the B half in a semi-circular motion, with the hinge 23 acting as a pivot.

Also shown in FIG. 5, once the A half is folded over the B half, the notches 34a and 34a′ become available for other use. For example, a skew 53 (or a stick) having food items (not shown) attached thereto may be placed in these notches to cook the food items on the stick. In accordance with some embodiments of the invention, additional notches (in addition to 34a, 34a′, 34b, 34b′) may be included on the outside frame 31 so that more skews may be cooked while the grill is folded in half.

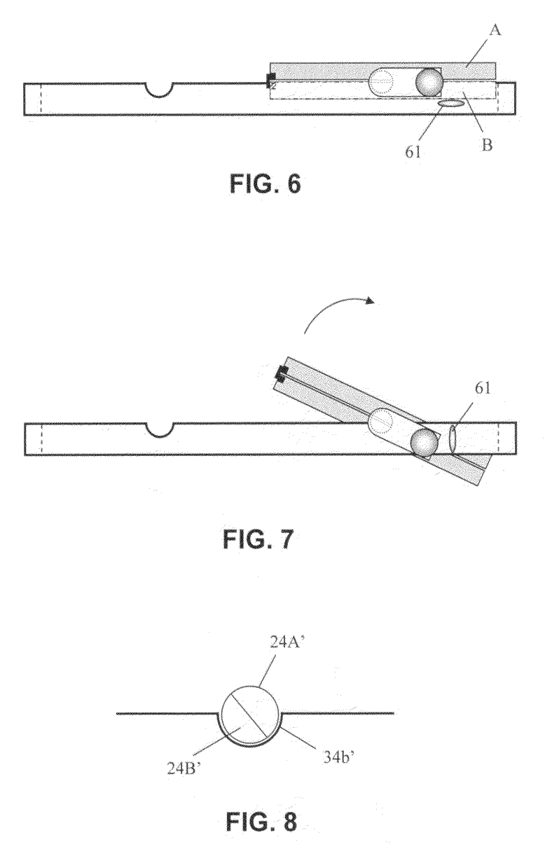

FIG. 6 illustrates a side view of the folded grill assembly shown in FIG. 5. It is clear from this view, the A half folds on top of the B half. The food items that were originally placed on top of the B half (and A half, if any) will now be trapped between the A half and B half. Since the food items are trapped between the two halves, there is no danger of having these food items falling out when the grill is turned or flipped.

As shown in FIG. 6, the grill frame may have a stop mechanism 61 that can prevent the folded grill from rotating until the user decides to rotate the grill. The stop mechanism 61 may be a knob, as shown in FIG. 6, that prevents the handle from turning further. Alternatively, the stop mechanism 61 may be a mechanism that stops the turning of the grill itself (rather than the handle). The stop mechanism 61 may be turned or switched to a second position when turning of the grill is desired (see FIG. 7).

FIG. 7 illustrates a configuration of the folded grill in the process of being turned (rotated) over. The turning (or rotation) action can be facilitated by the presence of handle 25 or, if no handle is present, by rotating an axle formed by the axle portions 24A′ and 24B′. Once the folded grill is turned 180 degrees, the A half will end up at the bottom, while the B half will be on top. Therefore, the top sides of the food items can now be cooked by the fire or heat from below.

In accordance with preferred embodiment of the invention, the axle portions 24A, 24A′, 24B, and/or 24B′ have half-cylinder configurations such that when the two halves are folded, these half cylinders combine to form a cylindrical axle structure to facilitate the turning or flipping of the grill, as illustrates in FIG. 8.

FIG. 8 illustrates a schematic that depicts the formation of a cylindrical axle from two axle portions 24A′ and 24B′, each of which is semi-cylinder in shape. The combined cylindrical axle in the folded grill can easily rotate in the notch 34b′. As illustrated in FIG. 8, the notch 34b′ also prevents the two axle portions 24A′ and 24B′ from separating during a rotation motion. Therefore, the food items will not accidentally fall off the grill.

Referring again to FIG. 7, in order for the folded grill to turn in the manner shown, some clearance at the bottom of the grill will be necessary. In accordance with embodiments of the invention, a grill assembly (such as 40 shown in FIG. 4) may be built into a barbeque equipment (e.g., a conventional barbeque equipment) or a cook top that has sufficient clearance to permit such turning. In accordance with some embodiments of the invention, a grill assembly as shown in FIG. 4 may be used as an “add-on” accessory for a conventional barbeque or cooking apparatus. In this case, the outside frame (e.g., 30 shown in FIG. 3) may include legs (or similar structures) to provided the needed clearance.

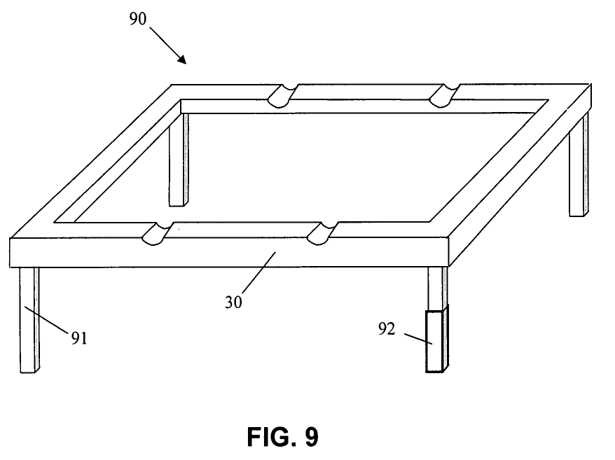

For example, FIG. 9 shows an outside frame 30 in accordance with one embodiment of the invention may include legs 91 to provide clearance on the lower side of the grill. In accordance with some embodiments of the invention, legs 91 may be adjustable in height (e.g., telescoping legs 92). One of ordinary skill in the art would appreciate that any suitable legs or similar structure (fixed or adjustable) may be used with embodiments of the invention. For example, U.S. Pat. No. 7,080,640, issued to Sanders et al., discloses a portable cooking grill having telescoping legs. Furthermore, although four legs are shown in FIG. 9, more or fewer legs may be used as long as they can serve the function to raise the grill frame.

In accordance with some embodiments of the invention, the plurality bars 22 shown in FIG. 2 may be arranged on a common plane to form a flat cooking surface. In accordance with other embodiments of the invention, the plurality of wires or rods 22 may be arranged in a non-coplanar fashion to provide a unique cooking “cage” when the A half is folded over the B half of the frill.

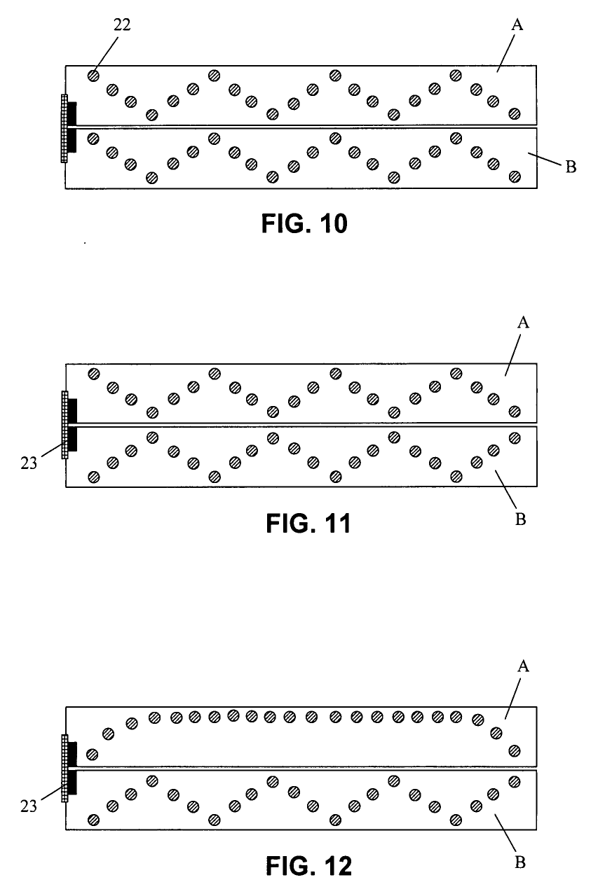

As illustrated in FIG. 10, which depicts a side view of a folded grill in accordance with one embodiment of the invention, the bars 22 are arranged in a wavy pattern such that the cooking space between the two halves of the grill is not a flat walled chamber. Having a wavy “cooking chamber” will help prevent slipping of food items when the folded grill is turned.

The embodiment shown in FIG. 10 has the wavy patterns on the A half and the B half of a grill arranged such that the two wavy patterns are “in step” when the grill is folded. FIG. 11 illustrates an alternative arrangement of the bars 22 such that the wavy patterns of the A half and the B half are not in step (“out of step”) when folded. The embodiment of FIG. 11 can also prevent slippage of food items during rotation. In addition, the embodiment of FIG. 11 can better accommodate food items that are larger, such as hot dogs or corns.

FIG. 12 shows yet another variation of the arrangements of bars in the grill. As shown, the bars in the A half of the grill is arranged in a dish-like concave pattern, while that in the B half remains a wavy pattern. This configuration has a chamber with more volumes to accommodate food items and yet the wavy pattern on the B half still can prevent or minimize food item slippage during rotation. If more volume is desired, the bars in the B half may also be arrange in the dish-like concave pattern. One or ordinary skill in the art would appreciate that the examples shown here are for illustration only and other modifications and variations are possible without departing from the scope of the invention.

In accordance with some embodiments of the invention, the A half and B half of a grill can be reversibly detached and reattached at the hinge region by a user. With such embodiments, a user can detach the B half from the A half, flip the B half, and reattach the two halves. By doing so, a user can reconfigure a grill shown in FIG. 10 to that shown in FIG. 11, and vice versa.

Embodiments of the present invention may include one or more of the following advantages. Grills of the invention allow users to easily cook both sides of food items without the clumsiness of using conventional utensils. Grills of the invention can be used as add-ons for existing barbeque apparatus or be built into new barbeque equipment.

While the invention has been described with respect to a limited number of embodiments, those skilled in the art, having benefit of this disclosure, will appreciate that other embodiments can be envisioned that do not depart from the scope of the invention as disclosed herein. Accordingly, the scope of the invention shall be limited only by the attached claims.

What is claimed is:

1. A grill assembly, comprising:
a grill frame having a first pair of notches on a first side of the grill frame and a second pair of notches on another side of the grill frame that is opposite the first side, wherein the first pair of notches and the second pair of notches are aligned along two axes of rotation that are substantially perpendicular to the first side of the grill frame; and
a grill comprising two halves held together by a hinge such that the two halves can be folded to face each other, and four axle portions that are configured to fit in the first pair of notches and the second pair of notches of the grill frame.

2. The grill assembly of claim 1, wherein the grill further comprises a handle attached to one of the four axle portions.

3. The grill assembly of claim 1, wherein the grill frame further comprises legs for raising the grill assembly.

4. The grill assembly of claim 3, wherein the legs are removably attached to the grill frame.

5. The grill assembly of claim 3, wherein the legs are adjustable for raising the grill assembly to different heights.

6. The grill assembly of claim 1, wherein the grill assembly is fixed to a barbeque equipment.

7. the grill assembly of claim 1, wherein the grill comprises a plurality of bars arranged in a wavy pattern.

8. The grill assembly of claim 7, wherein the wavy pattern is such that when the two halves of the grill are in a folded configuration the wavy pattern is in step between the two halves.

9. The grill assembly of claim 7, wherein the wavy pattern is such that when the two halves of the grill are in a folded configuration the wavy pattern is out of step between the two halves.

10. The grill assembly of claim 1, wherein the two halves of the grill are reversibly attached via the hinge.
